(19) United States
(12) Patent Application Publication
(10) Pub. No.: US 2019/0125613 A1
(43) Pub. Date: May 2, 2019

(54) WALKING ASSISTANCE DEVICE

(71) Applicant: Meconik Co., Ltd, Seoul (KR)

(72) Inventors: Mi Jeong KIM, Seoul (KR); Seung Jong KIM, Gimpo-si, Gyeonggi-do (KR); Sung Mo KIM, Seoul (KR)

(73) Assignee: Meconik Co., Ltd, Seoul (KR)

(21) Appl. No.: 16/093,654

(22) PCT Filed: Apr. 14, 2017
(86) PCT No.: PCT/KR2017/004072

§ 371 Date: Oct. 15, 2018

(30) Foreign Application Priority Data
Apr. 15, 2016 (KR) 10-2016-0046202
Jun. 28, 2016 (KR) 10-2016-0080890
Jun. 28, 2016 (KR) 10-2016-0080896
Jun. 28, 2016 (KR) 10-2016-0080903
Jun. 28, 2016 (KR) 10-2016-0080933

(51) Int. Cl. A61H 3/00; A61H 1/02

(52) U.S. Cl. CPC A61H 3/00; A61H 1/0262; A61H 2003/007; A61H 2201/1652; A61H 2201/163; A61H 2201/1642; A61H 2201/149

(57) ABSTRACT

A walking assistance device includes: an upper body disposed on a thigh of a user; a lower outer body rotatably connected to the upper body and disposed on a calf of the user; a lower inner body disposed to at least partially overlap the lower outer body; a first elastic portion which has a bent part in contact with the ground so as to provide an elastic force during a user's walk; an Achilles tendon portion connected to one end of the first elastic portion and slidably connected to the lower outer body and the lower inner body; a second elastic portion interposed between the upper body and the lower outer body; and a loading potion which is connected to a bent part of the second elastic portion and movably installed in the lower outer body.

### BACKGROUND

### 1. Field

The following description relates to a device, and more particularly, to a walking assistance device.

### 2. Description of Related Art

Humans use a complex formation of, for example, knee joints, ankles, Achilles tendons, calves, thighs, ligaments and muscles for walking. However, if one of the complex formation malfunctions, it becomes uncomfortable to walk and it moreover may cause a great obstacle to social activities. To address such drawbacks, various forms of walking assistance devices are being developed. In addition, when a function of the above-described complex formation is deteriorated, rehabilitation training may be performed to restore the function and a walking assistance device may be utilized in such rehabilitation training.

However, when one in the complex formation has degenerated due to aging or damage, it may occur that the degenerated part cannot be recovered through the rehabilitation training. In this case, a separate walking assistance device may be used to assist.

For example, such a walking assistance device has been developed in such a form that wheels are provided on a lower part thereof and a user is supported by grasping and propelling the walking assistance device. In this case, if a problematic situation occurs, such as when the user has insufficient arm strength, the user may not able to use the walking assistance device.

In addition, when even a normal person carries a heavy object, an excessive load may be applied to a part of the body, that is, a leg portion, which may result in injury. To solve such a problem, there is a need to develop a device capable of assisting with a user's walk.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a walking assistance device.

In one general aspect, there is provided a walking assistance device including: an upper body disposed on a thigh of a user; a lower outer body rotatably connected to the upper body and disposed on a calf of the user; a lower inner body disposed to at least partially overlap the lower outer body; a first elastic portion which has a bent part in contact with the ground so as to provide an elastic force during a user's walk; an Achilles tendon portion connected to one end of the first elastic portion and slidably connected to the lower outer body and the lower inner body; a second elastic portion interposed between the upper body and the lower outer body, thereby rotatably connecting the upper body and the lower outer body; and a loading potion which is connected to a bent part of the second elastic portion and movably installed in the lower outer body, and has a part in contact with the Achilles tendon portion to provide a force to the bent part of the second elastic portion according to a motion of the Achilles tendon portion.

In another general aspect, there is provided a walking assistance device including: an upper body disposed on a thigh of a user; a lower outer body rotatably connected to the upper body and disposed on a calf of the user; a lower inner body disposed to at least partially overlap the lower outer body; a first elastic portion which has a bent part in contact with the ground, thereby providing an elastic force during a user's walk; an Achilles tendon portion connected to one end of the first elastic portion and slidably connected to the lower outer body and the lower inner body; and a first linear motion portion which is installed slidably with respect to the lower inner body and connected to the Achilles tendon portion and linearly moves with respect to the lower inner body according to a motion of the Achilles tendon portion.

In still another general aspect, there is provided a walking assistance device including: an upper body disposed on a thigh of a user; a lower outer body rotatably connected to the upper body and disposed on a calf of the user; a first elastic portion which has a bent part in contact with the ground to provide an elastic force during a user's walk; an Achilles tendon portion connected to one end of the first elastic portion and slidably connected to the lower outer body and the lower inner body; a fourth elastic portion which is installed in the lower inner body and is connected to the Achilles tendon portion to provide a restoring force to the Achilles tendon portion according to a motion of the Achilles tendon portion; and a fourth elastic connector connected to the fourth elastic portion and linearly-movably inserted into the Achilles tendon portion.

The first elastic portion may include: a first elastic body portion on which a shoe is seated; a second elastic body portion formed to be bent from the first elastic body portion and be in contact with the ground; and a first elastic connector rotatably connected to the first and second elastic body portion and allowing the first and second elastic body portions to form a predetermined angle.

At least a part of the Achilles tendon portion may be formed of a flexible material.

The Achilles tendon portion may include: an Achilles tendon body portion slidably connected to the lower outer body and the lower inner body; and a projection portion which is formed to protrude from the Achilles tendon body portion to an inside of the lower outer body and is partially in contact with the loading portion to apply a force to the loading portion. A concavo-convex shape may be formed on an outer surface of at least a part of the Achilles tendon body portion to allow a shape of the Achilles tendon body to be varied.

The walking assistance device may further include a second connector rotatably connected to the first linear motion portion. In addition, the walking assistance device may further include a third elastic portion having one end installed in the lower inner body and the other end connected to the second connector to provide a restoring force to the first linear motion portion. Also, the first linear motion portion may include: a first linear motion body portion disposed linearly movably with respect to the lower inner body and connected to the Achilles tendon portion; and a first linear roller connected to the first linear motion body portion and the second connector and slidably installed in the lower inner body.

The walking assistance device may further include a locking portion installed in the lower inner body and selectively restraining a part of the fourth elastic portion.

The Achilles tendon portion may include a release projection which is disposed to be inserted into the lower outer body and releases the restraint of the fourth elastic portion by being brought into contact with the locking portion and moving the locking portion according to a motion of the Achilles tendon portion.

The walking assistance device may further include a fifth elastic portion installed in the lower inner body and selectively connected to the fourth elastic portion via a first wire to apply a force to the fourth elastic portion according to a motion of the fourth elastic portion.

The walking assistance device may further include a length-adjusting portion installed in the lower inner body and coupled with at least one of the fourth elastic portion and the fifth elastic portion to vary an initial position of at least one of the fourth elastic portion and the fifth elastic portion.

The length-adjusting portion may include: an upper body fixing portion fixed to the lower inner body; a rotary portion rotatably installed on the upper body fixing portion; and a lower outer body fixing portion into which the rotary portion is rotatably installed and which is fixed inside of at least one of the fourth elastic portion and the fifth elastic portion.

The walking assistance device may further include a fifth elastic connector which is linearly movably inserted into the lower inner body and the Achilles tendon portion and is connected to the fifth elastic portion. In addition, the walking assistance device may further include a sixth elastic portion installed inside the fifth elastic portion and connected to the first wire. Also, the walking assistance device may further include a fifth elastic loading portion which is installed on the first wire and is selectively in contact with the fifth elastic connector.

The walking assistance device may further include a seventh elastic portion which is rotatably connected to the fifth elastic connector and connected to a shoe-securing portion for securing a shoe to provide a restoring force to at least one of the fifth elastic connector and the shoe-securing portion.

The loading portion may include: a first moving portion linearly moving inside the lower outer body; a loading connector connected to the first moving portion; a second moving portion connected to the loading connector and moving inside the lower outer body during a motion of the first moving portion; a path guide portion which is installed on the lower outer body and guides a path along which the moving portion internally moves; and a loading elastic portion which moves the second moving portion by applying a restoring force thereto and moves in contact with the Achilles tendon portion. In addition, the loading connector may be foldable. Moreover, a position of the path guide portion may be variable.

The path guide portion may include a first path guide portion along which the second moving portion moves and a second path guide portion which is formed to protrude from the first path guide portion and guides the second moving portion to a path different from a path of the second moving portion moving along the first path guide portion.

The loading portion may further include an eighth elastic portion which is installed on the lower outer body and connected to the loading elastic portion to provide a restoring force to the loading elastic portion.

The loading portion may further include a contact portion which is slidably installed on the lower outer body and is selectively brought into contact with the Achilles tendon portion according to a motion of the Achilles tendon portion, thereby moving the loading elastic portion.

The walking assistance device may further include: an auxiliary elastic portion connected to the lower outer body and having one end in contact with the second elastic portion; and a coupling member which is installed at a center of the second elastic portion and at which a center of the auxiliary elastic portion is installed.

The walking assistance device may further include an elastic force adjusting portion installed on one end of the auxiliary elastic portion and rotatably installed on the coupling member.

Other features and aspects will be apparent from the following detailed description, the drawings, and the claims.

### BRIEF DESCRIPTION OF THE DRAWINGS

FIG. 1 is a conceptual diagram illustrating a walking assistance device.

FIG. 2 is a conceptual diagram illustrating a part of the walking assistance device of FIG. 1.

FIG. 3 is a conceptual diagram illustrating an Achilles tendon portion shown in FIG. 2.

FIG. 4 is a conceptual diagram illustrating a first linear motion portion shown in FIG. 2.

FIG. 5 is a conceptual diagram illustrating part A shown in FIG. 1.

FIG. 6 is a conceptual diagram illustrating an arrangement order of a fourth elastic portion, a locking portion, a fifth elastic portion, a length-adjusting portion, a fifth elastic connector, and a sixth elastic portion, which are shown in FIG. 5.

FIG. 7 is a conceptual diagram illustrating the fourth elastic portion, the fourth elastic connector, the locking portion, the fifth elastic portion, the length-adjusting portion, the fifth elastic connector, and the sixth elastic portion which are shown in FIG. 5.

FIG. 8 is a conceptual diagram illustrating one embodiment of a loading portion shown in FIG. 1.

FIG. 9 is a conceptual diagram illustrating one embodiment of a path guide portion in which the loading portion shown in FIG. 8 is installed.

FIG. 10 is a conceptual diagram illustrating a second elastic portion, an auxiliary elastic portion, and a coupling member of a walking assistance device according to another embodiment of the present invention.

FIG. 11 is a conceptual diagram illustrating an auxiliary elastic portion, an elastic force adjusting portion, and a restraining portion of a walking assistance device according to still another embodiment of the present invention.

FIG. 12 is a conceptual diagram illustrating an operational state of the walking assistance device shown in FIG. 1.

FIG. 13 is a conceptual diagram illustrating a part of the walking assistance device shown in FIG. 12.

FIG. 14 is a conceptual diagram illustrating an operational state of a second elastic portion shown in FIG. 12.

FIG. 15 is a conceptual diagram illustrating another embodiment of the loading portion and path guide portion shown in FIG. 9.

FIG. 16 is a conceptual diagram illustrating a path guide portion shown in FIG. 14.

FIG. 17 is a conceptual diagram illustrating a fourth elastic portion, a fourth elastic connector, a locking portion, a fifth elastic portion, a length-adjusting portion, a fifth elastic connector, and a sixth elastic portion, which are shown in FIG. 12.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the present invention will be described more fully with reference to the accompanying drawings, in which example embodiments of the present invention are shown. The present invention may, however, be embodied in many different forms and should not be construed as necessarily being limited to the example embodiments disclosed herein. Rather, the example embodiments are provided so that the present invention is thorough and complete and fully conveys the concepts of the present invention to those skilled in the relevant art. Like numbers refer to like elements throughout the drawings and the detailed description. The terminology used herein is for the purpose of describing particular embodiments only and is not intended to be limiting to the invention. As used herein, the singular forms “a”, “an,” and “the” are intended to include the plural forms as well, unless the context clearly indicates otherwise. It will be further understood that the terms “comprises” and/or “comprising,” when used in this specification specify the presence of stated features, integers, steps, operations, elements, and/or components, but do not preclude the presence or addition of one or more other features, integers, steps, operations, elements, components, and/or groups thereof. It will be understood that, although the terms first, second, etc. may be used herein to describe various elements, these elements should not be limited by these terms. These terms are only used to distinguish one element from another.

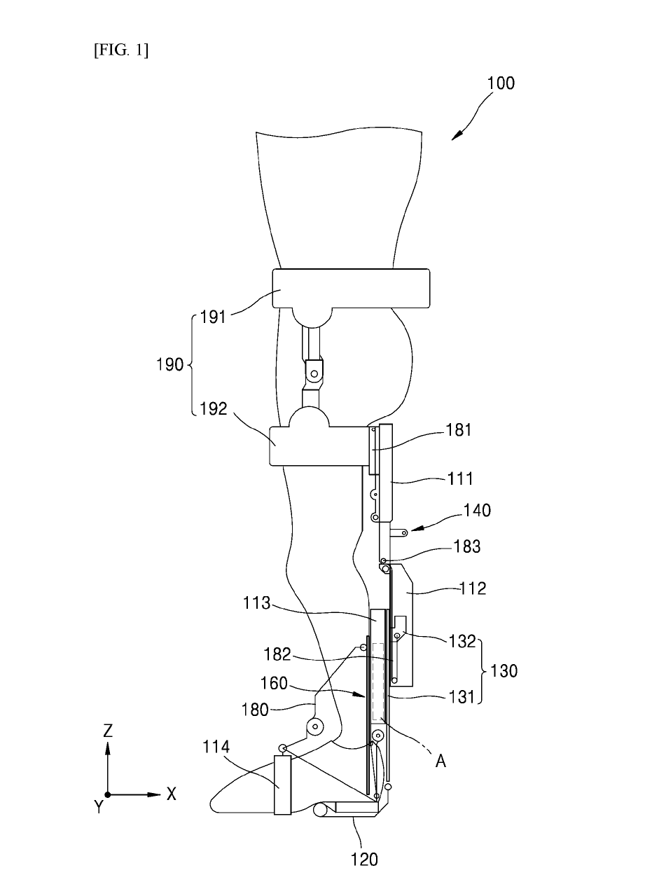

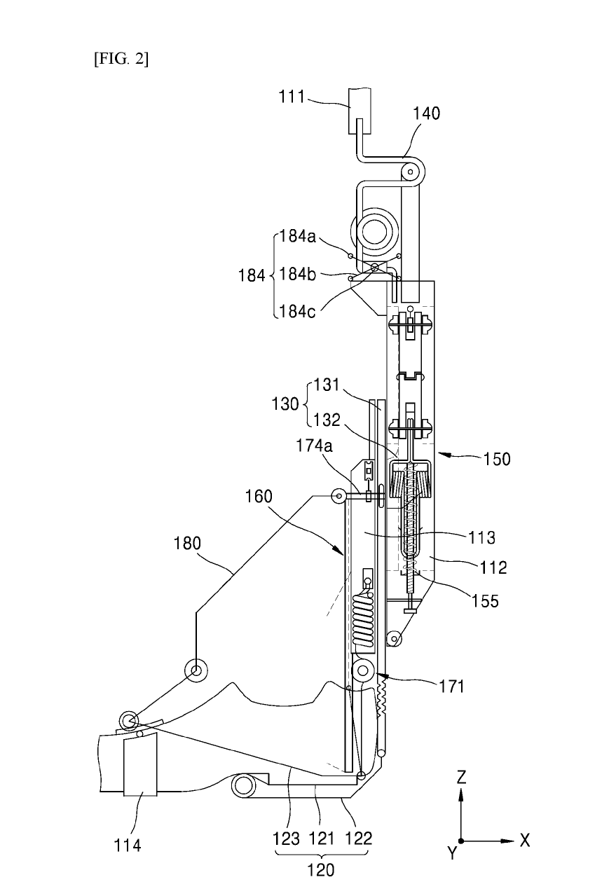

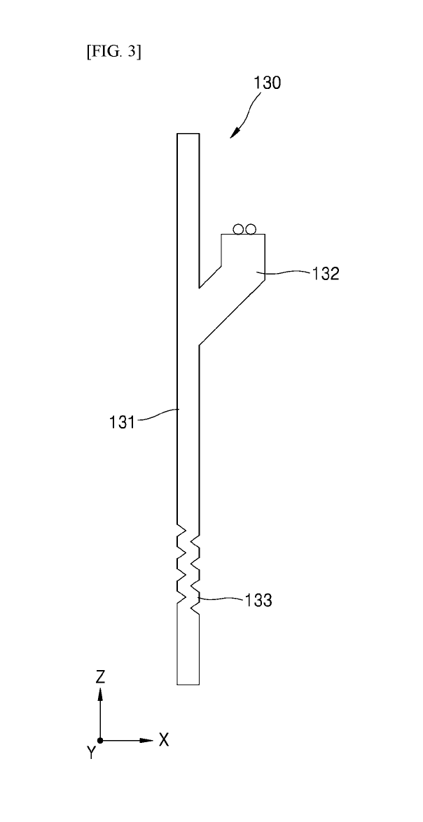

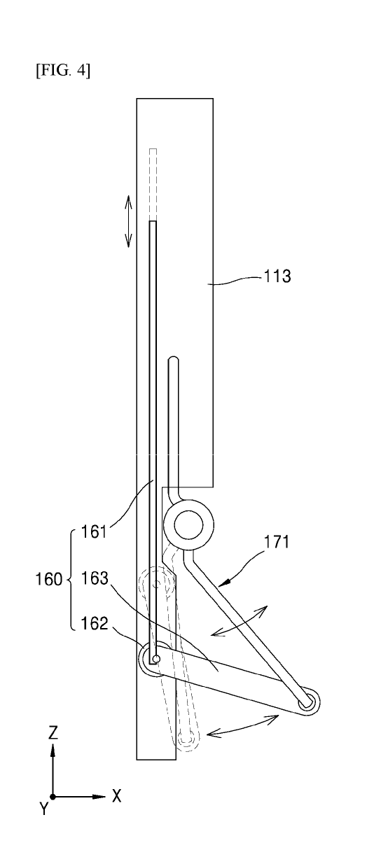

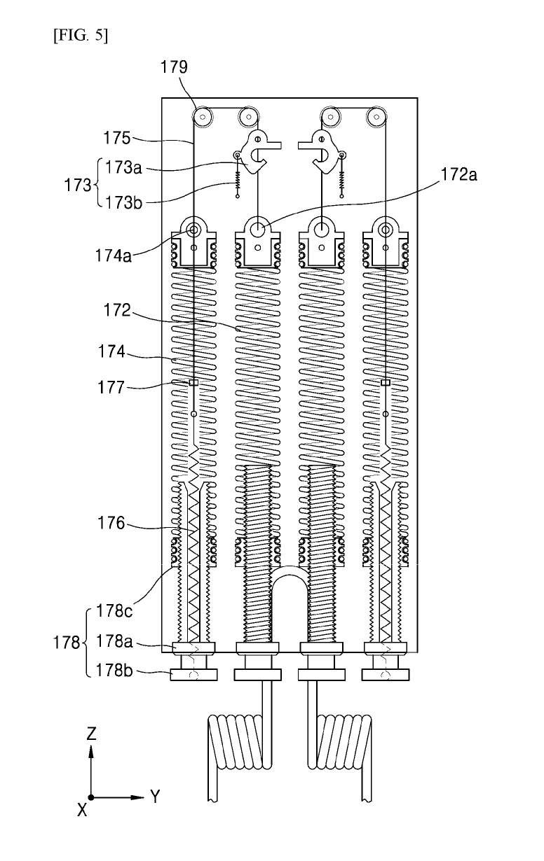

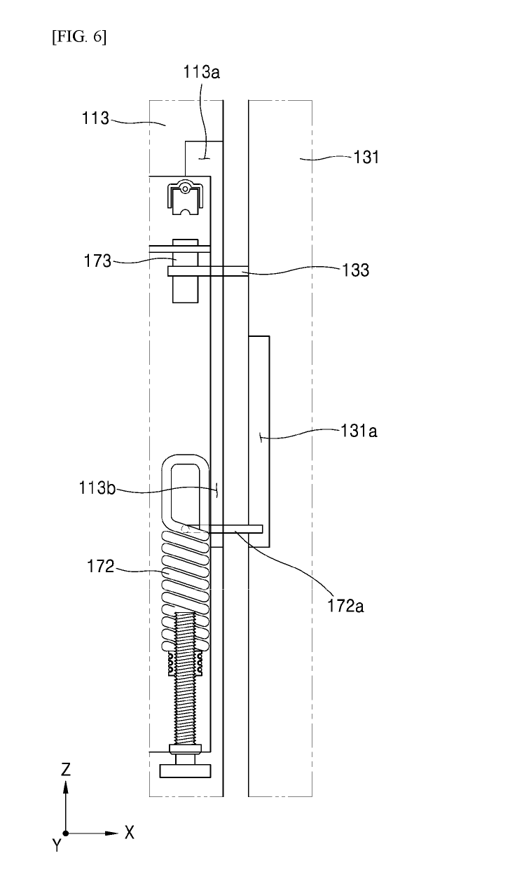

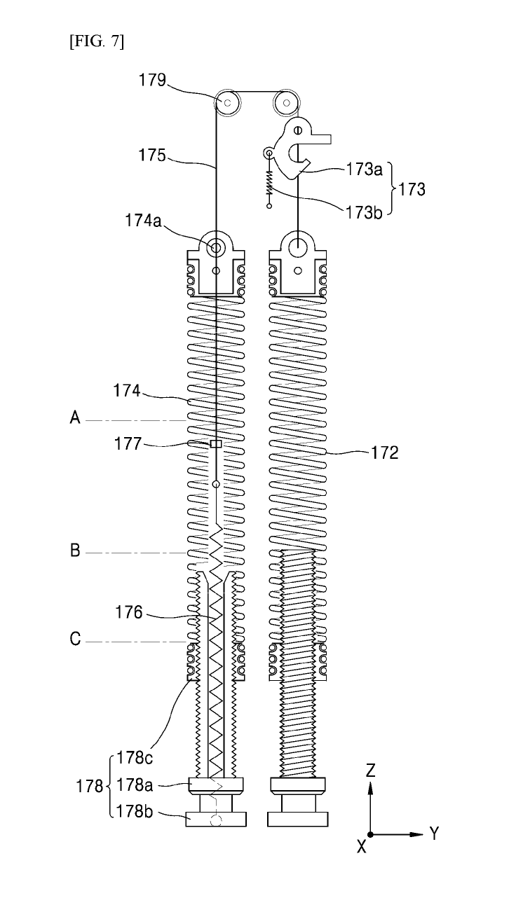

FIG. 1 is a conceptual diagram illustrating a walking assistance device, FIG. 2 is a conceptual diagram illustrating a part of the walking assistance device of FIG. 1, FIG. 3 is a conceptual diagram illustrating an Achilles tendon portion shown in FIG. 2, FIG. 4 is a conceptual diagram illustrating a first linear motion portion shown in FIG. 2, FIG. 5 is a conceptual diagram illustrating part A shown in FIG. 1, FIG. 6 is a conceptual diagram illustrating the arrangement order of a fourth elastic portion, a locking portion, a fifth elastic portion, a length-adjusting portion, a fifth elastic connector, and a sixth elastic portion, which are shown in FIG. 5, and FIG. 7 is a conceptual diagram illustrating the fourth elastic portion, the fourth elastic connector, the locking portion, the fifth elastic portion, the length-adjusting portion, the fifth elastic connector, and the sixth elastic portion which are shown in FIG. 5.

Referring to FIGS. 1 to 7, the walking assistance device 100 may include an upper body 111, a lower outer body 112, a lower inner body 113, a shoe-securing portion 114, a first elastic portion 120, an Achilles tendon portion 130, a second elastic portion 140, a loading portion 150, a securing portion 190, a first linear motion portion 160, a second connector 163, a third elastic portion 171, a fourth elastic portion 172, a fourth elastic connector 172a, a locking portion 173, a fifth elastic portion 174, a length-adjusting portion 178, a fifth elastic connector 174a, a sixth elastic portion 176, a fifth elastic loading portion 177, a seventh elastic portion 189, a cushioning portion 181, and a distance adjuster 184.

The upper body 111 may be placed on a thigh of a user. In this case, the upper body 111 may be fabricated to correspond to the shape of the user's body. The lower outer body 112 may be placed on a calf of the user. In this case, the lower outer body 112 may be formed in the shape of a plate and may be formed three-dimensionally to have a specific volume.

The lower inner body 113 may be placed on a calf portion of the user similarly to the lower outer body 112. In this case, the lower inner body 113 may be disposed to at least partially overlap the lower outer body 112.

The shoe-securing portion 114 may secure a user's shoe, particularly, a front portion of the shoe. A part of the shoe-securing portion 114 which secures a shoe may be formed of a Velcro type, a strap type, or the like so as to enclose the user's shoe.

The first elastic portion 120 may include a first elastic body portion 121, a second elastic body portion 122, and a first elastic connector 123.

The first elastic body portion 121 may have the shoe seated. The first elastic body portion 121 may have a flat part and the shoe may be seated on the flat part.

The second elastic body portion 122 may be formed to be bent from the first elastic body part 121 and have a part in contact with the ground. The second elastic body portion 122 may be connected to the Achilles tendon portion 130. The second elastic body portion 122 may be close to or spaced apart from the first elastic body portion 121 so as to provide a restoring force that can assist the user in walking during a user's walk.

The first elastic connector 123 may be rotatably connected to one end of each of the first and second elastic body portions 121 and 122. The first elastic connector 123 may allow the first and second elastic body portions 121 and 122 to form a predetermined angle therebetween so that a restoring force which enables them to restore to initial states is provided when deformation occurs.

The Achilles tendon portion 130 may be slidably connected to the lower outer body 112 and the lower inner body 113. The Achilles tendon portion 130 may be connected to one end of the first elastic portion 120 so that the lower outer body 112 may be allowed to slide according to a change of a shape of the first elastic portion 120. Particularly, the Achilles tendon portion 130 may linearly move along an outer surface of the lower outer body 112.

The Achilles tendon portion 130 may include an Achilles tendon body portion 131 and a projection portion 132. At least a part of the Achilles tendon body portion 131 may be disposed between the lower outer body 112 and the lower inner body 113. In this case, the Achilles tendon body portion 131 may be slidably coupled to the lower outer body 112 and the lower inner body 113.

At least a part of the Achilles tendon portion 130, particularly, the Achilles tendon body portion 131, may be formed of a flexible material. The flexible material may include rubber, pliable metal, silicone, and the like. In this case, when an angle formed by the calf and a foot varies, for example when the user bends his/her foot, a part of the Achilles tendon portion 130 may be folded or varied, so that the user's motion is not restricted.

The Achilles tendon portion 130 may include a bent portion 133 formed at the Achilles tendon body portion 131. The bent portion 133 may be formed in a concavo-convex shape on a surface of at least a part of the Achilles tendon body portion 131. For example, the bent portion 133 may have a certain degree of deformability as grooves are formed on the surface of at least a part of the Achilles tendon body portion 131.

The projection portion 132 may be formed to protrude from the Achilles tendon body portion 131 to the inside of the lower outer body 112 and be partially in contact with the loading portion 150 to exert a force to the loading portion 150. In this case, the projection portion 132 may be inserted into the lower outer body 112 and the lower outer body 112 into which the projection portion 132 is inserted may have a long hole so that the projection portion 132 may move through the long hole of the lower outer body 112.

An upper part of the projection portion 132 may be in contact with a part of the loading portion 150 or a groove may be formed to enable the part of the loading portion 150 to be inserted thereinto.

In addition to the above-described elements, the Achilles tendon portion 130 may include a release projection 133 which is inserted into the lower outer body 112. In this case, the release projection 133 may be formed to extend from the Achilles tendon body portion 131.

The release projection 133 may protrude from the Achilles tendon body portion 131 and be inserted into the lower outer body 112. In this case, the lower outer body 112 may have a lower outer body long hole 113a formed along a length direction of the lower outer body 112 so that the release projection 133 can move when the Achilles tendon body linearly moves.

The above-described release projection 133 may be brought into contact with the locking portion 173 to move the locking portion 173 according to the motion of the Achilles tendon body portion 131 so that restraint of the fourth elastic portion 172 by the locking portion 173 can be released.

The second elastic portion 140 may be interposed between the upper body 111 and the lower outer body 112 so that the upper body 111 and the lower outer body 112 can be rotatably connected to each other. In this case, the second elastic portion 140 may be placed on a knee portion of the user so that when the user bends a leg, a restoring force can be provided to the upper body 111 and the lower outer body 112 according to an angle at which a leg of the user is bent. Particularly, the second elastic portion 140 may support the load of the user applied to the upper body 111 when the upper body 111 and the lower outer body 112 are not arranged in a straight line.

The second elastic portion 140 as described above may be used solely. In another embodiment, the second elastic portion 140 may be used together with an auxiliary elastic portion (not shown). Hereinafter, a detailed description will be made of a case in which the second elastic portion 140 is used solely. A case in which the second elastic portion 140 is used together with the auxiliary elastic portion will be described in detail with reference to other drawings.

The loading portion 150 may be connected to a bent part of the second elastic portion 140 and may be movably installed on the lower outer body 112. In this case, a part of the loading portion 150 may be in contact with the Achilles tendon portion 130 to apply a force to the bent part of the second elastic portion 140 according to the motion of the Achilles tendon portion 130. The loading portion 150 will be described in detail below.

The securing portion 190 may be installed to be connected to at least one of the upper body 111 and the lower outer body 112. In this case, the securing portion 190 may secure at least one of the upper body 111 and the lower outer body 112 to a part of the user's body. For example, the securing portion 190 may include a first securing portion 191 which is connected to the upper body 111 and installed on a waist of the user. In addition, the securing portion 190 may include a second securing portion 192 which is connected to the upper body 111 and installed on the thigh of the user. Also, the securing portion 190 may include a third securing portion (not shown) which is connected to at least one of the lower outer body 112 and the lower outer body 113 and installed on the calf of the user. However, for convenience of description, a detailed description will be made of a case in which the securing portion 190 includes the first securing portion 191 and the second securing portion 192.

The first linear motion portion 160 may be installed slidably with respect to the lower inner body 113. In this case, the first linear motion portion 160 may be disposed inside the lower inner body 113 or interposed between the calf and the lower inner body 113. The first linear motion portion 160 may linearly move with respect to the lower inner body 113 according to the motion of the Achilles tendon portion 130.

The first linear motion portion 160 may include a first linear motion body portion 161 and a first linear roller 162. In this case, the first linear motion body portion 161 may be connected to the Achilles tendon portion 130 and linearly move along a length direction (or a height direction) of the lower inner body 113 in accordance with the motion of the Achilles tendon portion 130. In addition, the first linear roller 162 may be rotatably installed on the first linear motion body portion 161 to reduce a frictional force during the motion of the first linear motion body portion 161. In particular, the first linear roller 162 may be slidably disposed inside the lower inner body 113.

The second connector 163 may be rotatably connected to the first linear roller 162. In this case, the second connector 163 may be formed in a bar shape.

The third elastic portion 171 may have both ends connected to the second connector 163 and the lower inner body 113, respectively. The third elastic portion 171 may provide a restoring force to the first linear motion portion 160 when the first linear motion portion 160 linearly moves.

The fourth elastic portion 172 may be installed in the lower inner body 113. In this case, the fourth elastic portion 172 may be connected to the Achilles tendon portion 130 to provide a restoring force to the Achilles tendon portion 130 according to the motion of the Achilles tendon portion 130. In this case, an upper part of the fourth elastic portion 172 may be formed to be caught by the locking portion 173.

The fourth elastic connector 172a may be connected to the fourth elastic portion 172. In this case, the fourth elastic connector 172a may penetrate the lower inner body 113 and be inserted into a fourth long hole 131a formed in the Achilles tendon portion 130. The fourth elastic connector 172a may move in contact with a lower part of the fourth long hole 131a according to the motion of the Achilles tendon portion 130, thereby varying the length of the fourth elastic portion 172.

The locking portion 173 may be installed in the lower inner body 113 and selectively restrain a part of the fourth elastic portion 172. Specifically, the locking portion 173 may include a locking hook 173a rotatably installed on the lower inner body 113 and a locking hook elastic portion 173b connecting the locking hook 173a and the lower inner body 113 to provide a restoring force to the locking hook 173a. In this case, the locking hook elastic portion 173b may be provided in the form of a torsion spring or a coil spring.

The locking hook 173a may have a groove into which a part of the fourth elastic portion 172 is inserted in accordance with the motion of the fourth elastic connector 172a. Also, the locking hook 173a may be formed to have a protruding part in contact with the release projection 133 of the Achilles tendon portion 130. In addition, in the case in which locking hook 173a rotates at a certain angle, the locking hook 173a may be formed to be secured to the lower inner body 113. For example, the locking hook 173a or one lower inner body 113 may have a projection protruding to the locking hook 173a or to another lower inner body 113 and the locking hook 173a or the other lower inner body 113 may have a groove which receives the projection so that the projection is inserted into the groove at a specific position to prevent the locking hook 173a from rotating. In another embodiment, the locking hook elastic portion 173b may be formed to provide a restoring force in a direction opposite to an initial direction when a rotation angle of the locking hook 173a exceeds a specific angle, and thereby the rotation of the locking hook 173a may be prevented. In this case, a method of fixing the locking hook 173a when the locking hook 173a rotates at a specific angle is not limited to the above description and various methods and structures may be included.

The fifth elastic portion 174 may be installed in the lower inner body 113 in parallel with the fourth elastic portion 172. In this case, the fifth elastic portion 174 may be selective connected to the fourth elastic portion 172 via a first wire 175.

The fifth elastic portion 174 may apply a force to the fourth elastic portion 172 according to the motion of the fourth elastic portion 172. In this case, an end of the fifth elastic portion 174 may be connected to the fifth elastic connector 174a.

The fifth elastic connector 174a may be disposed in the lower inner body 113 so as to pass through a fifth long hole (not shown) formed in the lower inner body 113 and a sixth long hole (not shown) of the Achilles tendon portion 130.

The sixth elastic portion 176 may be disposed inside the fifth elastic portion 174. In this case, the sixth elastic portion 176 may be connected to the fourth elastic portion 172 via the first wire 175. The sixth elastic portion 176 may maintain a tension of the first wire 175 between the sixth elastic portion 176 and the fourth elastic portion 172.

A fifth elastic loading portion 177 may be installed to be fixed to the first wire 175. In this case, the fifth elastic loading portion 177 may be selectively in contact with the fifth elastic connector 174a. In particular, when the fifth elastic loading portion 177 reaches a specific position, the fifth elastic loading portion 177 is brought into contact with the fifth elastic connector 174a, thereby varying the length of the fifth elastic portion 174.

The length-adjusting portion 178 may be disposed inside at least one of the fourth elastic portion 172 and the fifth elastic portion 174. In this case, the length-adjusting portion (not indicated) disposed inside the fourth elastic portion 172 may change an initial position of the fourth elastic portion 172. In particular, in a case in which the fourth elastic portion 172 is slightly stretched at an initial stage, a tension of the wire may be maintained or more force may be required to extend the fourth elastic portion 172.

In addition, the length-adjusting portion 178 disposed inside the fifth elastic portion 174 may be installed in the lower inner body 113 to vary relative positions of the fifth elastic portion 174 and the sixth elastic portion 176 so that forces generated from the fifth elastic portion 174 and the sixth elastic portion 176 may be controlled. Hereinafter, for convenience of description, a detailed description will be made of the length-adjusting portion 178 disposed inside the fifth elastic portion 174.

Specifically, the length-adjusting portion 178 may include an upper body fixing portion 178a fixed to the lower inner body 113 and a rotary portion 178b rotatably installed on the upper body fixing portion 178a. In this case, the sixth elastic portion 176 may be disposed inside the rotary portion 178b. Also, the length-adjusting portion 178 may include a lower outer body fixing portion 178c into which the rotary portion 178b is rotatably inserted and which is installed to be fixed to the inside of the fifth elastic portion 174.

The length-adjusting portion 178 as described above may vary a position of the sixth elastic portion 176. Specifically, in a case in which the rotary portion 178b rotates, spacing between the upper body fixing portion 178a and the lower outer body fixing portion 178c may vary. For example, in a normal state, the lower outer body fixing portion 178c may be placed at position A. In addition, when a weight of 30 kg more than the normal weight is carried, the lower outer body fixing portion 178c may be placed at position B which is lower than positon A.

In another embodiment, when a weight of 50 kg more than the normal weight is carried, the lower outer body fixing portion 178c may be placed at positon C which is lower than position B. In this case, the spacing between the upper body fixing portion 178a and the lower outer body fixing portion 178c differs between the former case and the latter case so that the initial elastic force of the fourth elastic portion 172 may be changed.

In this case, a position at which the fifth elastic loading portion 177 is in contact with the fifth elastic connector 174a may be adjusted by varying the distance between an end of the sixth elastic portion 176 and an end of the fifth elastic portion 174. In this case, a force applied to the fourth elastic portion 172 may be adjusted by changing the position at which the fifth elastic portion 174 and the sixth elastic portion 176 are simultaneously operated.

There may be provided a plurality of fourth elastic portions 172, fourth elastic connectors 172a, locking portions 173, fifth elastic portions 174, length-adjusting portions 178, fifth elastic connectors 174a, and sixth elastic portions 176. In particular, two fourth elastic portions 172, two fourth elastic connectors 172a and two locking portions 173 may form one group centrally disposed, and the fifth elastic portions 174, the length-adjusting portions 178, the fifth elastic connectors 174a, and the sixth elastic portions 176 may be symmetrically disposed at each side of the group. In this case, the first wire 175 may connect one fourth elastic portion 172, one fifth elastic portion 174, and one sixth elastic portion 176.

The lower inner body 113 may include a guide roller 179 which bends the first wire 175 connected to the fourth elastic portion 172 and guides the first wire 175 to the sixth elastic portion 176. In this case, the guide roller 179 may change a movement path of the first wire 175.

The seventh elastic portion 180 may have one end rotatably connected to the fifth elastic connector 174a. In addition, the other end of the fifth elastic portion 180 may be connected to the shoe-securing portion 114. In this case, the seventh elastic portion 180 may provide a restoring force to at least one of the shoe-securing portion 114 and the fifth elastic connector 174a.

The seventh elastic portion 180 may be provided in the form of a torsion spring. In this s case, the seventh elastic portion 180 may have a seventh elastic portion cover (not shown) installed at a central portion thereof.

The cushioning portion 181 may be connected to the Achilles tendon portion 130 via a second wire 182. In this case, the cushioning portion 181 may be connected to the projection portion 132 of the Achilles tendon portion 130. The second wire 182 may be in a state in which a tension is maintained through a bending roller 183 installed in each of the upper body 111 and the lower inner body 113.

The cushioning portion 181 may be deployed between the upper body 111 and the thigh according to the movement of the Achilles tendon portion 130. In this case, the cushioning portion 181 may include an elastic material, such as urethane, rubber, silicone, and the like. In another embodiment, the cushioning portion 181 may include a member serving as a buffer, such as an air cushion.

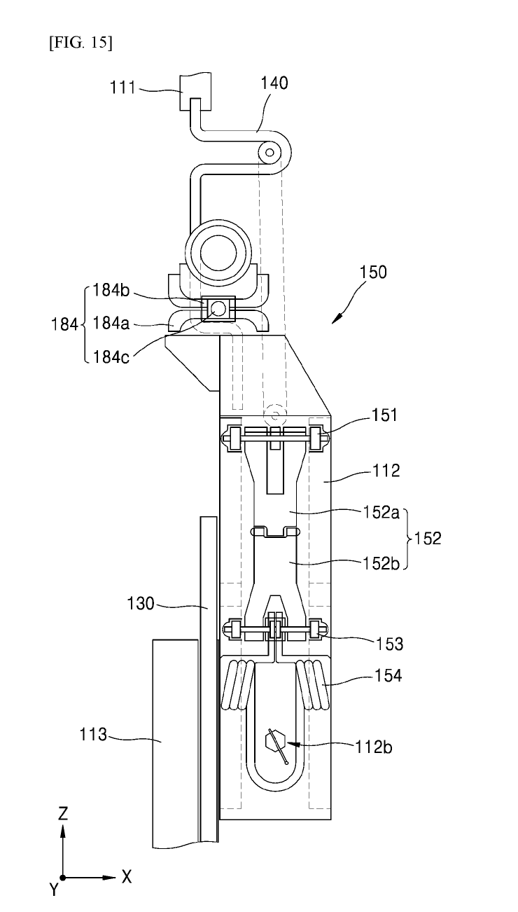

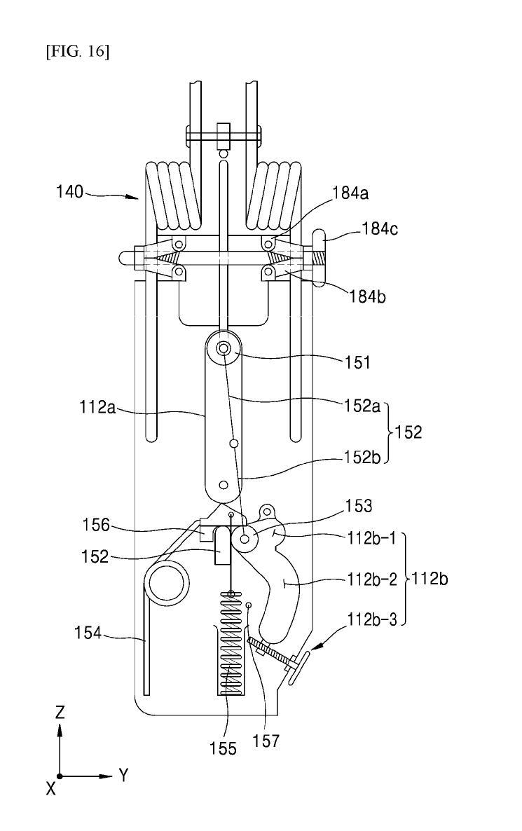

The distance adjusting portion 184 may adjust a distance between the lower outer body 112 and the center of the second elastic portion 140. In this case the distance adjusting portion 184 may include a link 184a rotatably connected to each of the lower outer body 112 and the second elastic portion 140, a distance adjustment position varying portion 184b connected to the link 184a and varying in its position, and a distance adjusting rotary portion 184c which is inserted into the distance adjustment position varying portion 184b and rotates to vary a position of the distance adjustment position varying portion 184b. In this case, the distance adjustment position varying portion 184b may be in the form of a nut and the distance adjusting rotary portion 184c may be in the form of a screw or a bolt (refer to FIGS. 15 and 16). In this case, the distance adjusting portion 184 may be detachably coupled to the lower outer body 112.

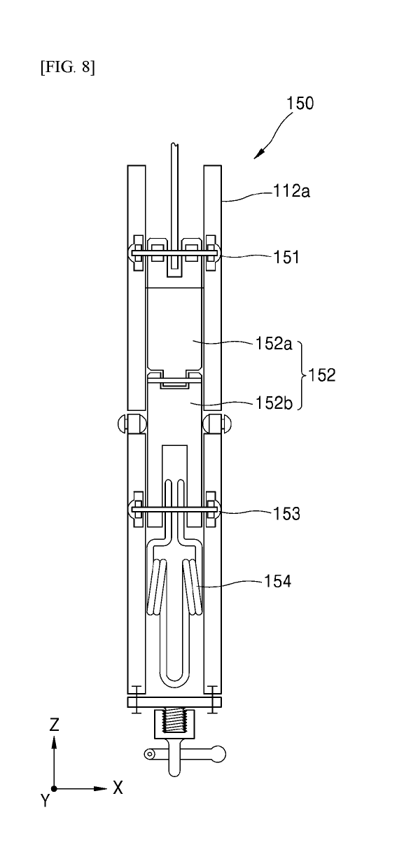

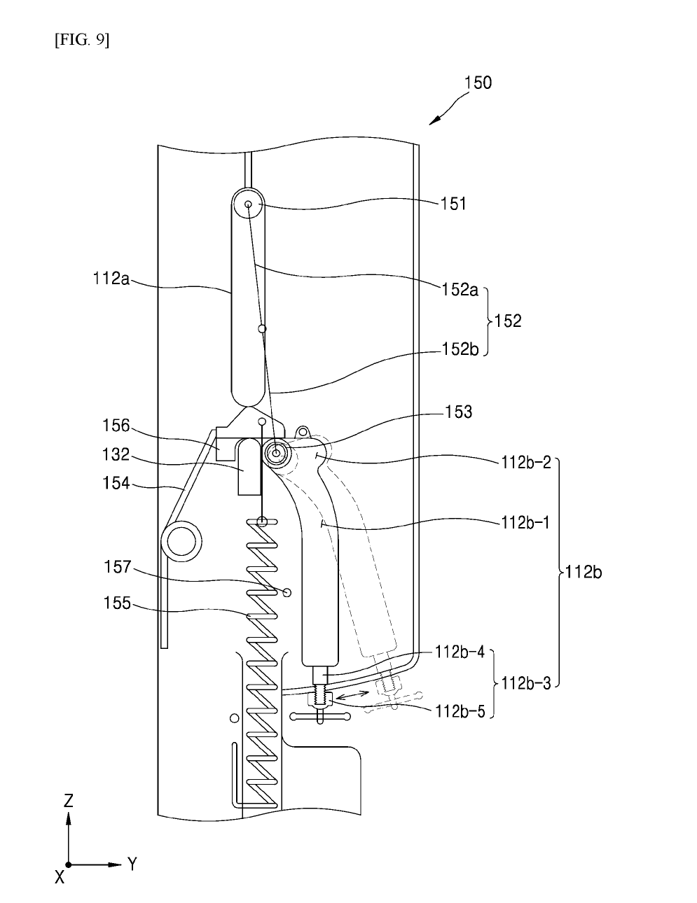

Hereinafter, the loading portion 150 will be described in detail. FIG. 8 is a conceptual diagram illustrating one embodiment of the loading portion shown in FIG. 1. FIG. 9 is a conceptual diagram illustrating one embodiment of a path guide portion in which the loading portion shown in FIG. 8 is installed.

Referring to FIGS. 8 and 9, the loading portion 150 may be installed inside the lower outer body 112. The loading portion 150 may apply a force to a bent part of the second elastic portion 140 according to the motion of the Achilles tendon portion 130. In this case, the loading portion 150 may be connected to the bent part of the second elastic portion 140 and vary a position of the bent part of the second elastic portion 140.

The loading portion 150 may include a first moving portion 151, a loading connector 152, a second moving portion 153, a loading elastic portion 154, an eighth elastic portion 155, and a contact portion 156.

The first moving portion 151 may be linearly movably installed inside the lower outer body 112. In this case, the lower outer body 112 may include a first movement guide portion 112a which guides a path along which the first moving portion 151 moves. The first movement guide portion 112a may be formed in the shape of a projection on the lower outer body 112 and form a boundary of the path along which the first moving portion 151 moves. In this case, the first moving portion 151 may be formed in the shape of a roller, be disposed to be inserted into the first movement guide portion 112a, and linearly moves along the first movement guide portion 112a.

The first moving portion 151 may be connected to a central part of the second elastic portion 140 via an additional member. In this case, a position of a bent part (or a central part) of the second elastic portion 140 is varied according to a movement of the first moving portion 151 so that a restoring force may be generated in the second elastic portion 140.

The loading connector 152 may be connected to the first moving portion 151 and move together with the first moving portion 151 when the first moving portion 151 moves. In this case, the loading connector 152 may include a first loading connector 152a and a second loading connector 152b which is rotatably connected to the first loading connector 152a.

The first loading connector 152a may be connected to the first moving portion 151 and be connected to the second loading connector 152b in the form of a hinge. The second loading connector 152b may be connected to the second moving portion 153 and the first loading connector 152a and the second loading connector 152b may be disposed to form a specific angle such that a connected portion protrudes rather than being flat. That is, the first loading connector 152a and the second loading connector 152b may be folded with each other in a specific circumstance.

The second moving portion 153 may be formed identically or similarly to the first moving portion 151. In this case, the second moving portion 153 may move along the path guide portion 112b arranged inside the lower outer body 112. In this case, the path guide portion 112b may be formed in the shape of a projection on the lower outer body 112 in a similar manner to the first movement guide portion 112a.

The above-described first moving portion 151 and second moving portion 153 may each be provided in the form of a roller.

The path guide portion 112b may include a first path guide portion 112b-1 along which the second moving portion 153 moves and a second path guide portion 112b-2 connected to the first path guide portion 112b-1.

The first path guide portion 112b-1 may guide the movement path of the second moving portion 153 when the first moving portion 151 moves. In this case, the first path guide portion 112b-1 may be provided in the curved form.

The second path guide portion 112b-2 may be connected to protrude from the first path guide portion. In particular, the second path guide portion 112b-2 may guide the second moving portion 153 to a path different from the path of the second moving portion 153 moving along the first path guide portion 112b-1 when the loading elastic portion 154 is operated. Particularly, when the loading elastic portion 154 moves back to an original position, the second path guide portion 112b-2 may avoid a movement path of one end of the loading elastic portion 154, thereby not obstructing the movement of the end of the loading elastic portion 154.

The path guide portion 112b may include a position adjusting portion 112b-3 which is connected to at least one of the first path guide portion 112b-1 and the second path guide portion 112b-2 and rotatably installed in the lower outer body 112. The position adjusting portion 112b-3 may include a position adjusting connector 112b-4 connected to one end of the path guide portion 112b and a position adjustment fixing portion 112b-5 rotatably installed in the position adjusting connector 112b-4 and securing the position adjusting connector 112b-4 by contacting the lower outer body 112. For example, the position adjusting connector 112b-4 may be in the form of a bar having a thread on an outer surface and the position adjustment fixing portion 112b-5 may be in the form of a nut. In this case, as the position adjustment fixing portion 112b-5 rotates, the position adjustment fixing portion 112b-5 is brought into contact with the lower outer body 112 and secures the position adjusting connector 112b-4.

When the position adjusting portion 112b-3 is disposed as described above, one end of the path guide portion 112b may be rotatably disposed on the lower outer body 112.

The loading elastic portion 154 may move the second moving portion 153 by applying a restoring force to the second moving portion 153. In this case, the loading elastic portion 154 may move in contact with the projection portion 132 of the Achilles tendon portion 130.

One end of the loading elastic portion 154 may be fixed to the lower outer body 112. In this case, the loading elastic portion 154 may be in the form of a torsion spring.

The eighth elastic portion 155 may be connected to the other end of the loading elastic portion 154 to provide a restoring force to the loading elastic portion 154 during the motion of the loading elastic portion 154. In this case, the eighth elastic portion 155 may be in the form of a coil spring. In particular, the eighth elastic portion 155 may be in a state of being stretched from an initial length. The lower outer body 112 may have a groove or the like in which the eighth elastic portion 155 can be installed. In addition, the same structure as the length- adjusting portion 179 may be installed on an end of the eighth elastic portion 112 so that an elastic force of the eighth elastic portion 155 may be adjusted.

The contact portion 156 may be slidably disposed on the lower outer body 112. In this case, the contact portion 156 may be interposed between the other end of the loading elastic portion 154 and the projection portion 132 of the Achilles tendon portion 130, and may be selectively in contact with the projection portion 132 to move the loading elastic portion 154. The above-described contact portion 156 may be installed or not installed according to the circumstance. However, for convenience of description, hereinafter, a detailed description will be made of a case in which the contact portion 156 is provided.

The lower outer body 112 may include a stopper 157 which restrict the movement of at least one of the loading elastic portion 154 and the contact portion 156. In this case, the stopper 157 may be provided in the form of a projection inside of the lower outer body 112, may be disposed at the lowermost end of the movement path of the contact portion 156, and may be disposed within a movement range of the other end of the loading elastic portion 154 so as to prevent the loading elastic portion 154 from returning to a state in which there is no elastic force during the movement of the loading elastic portion 154.

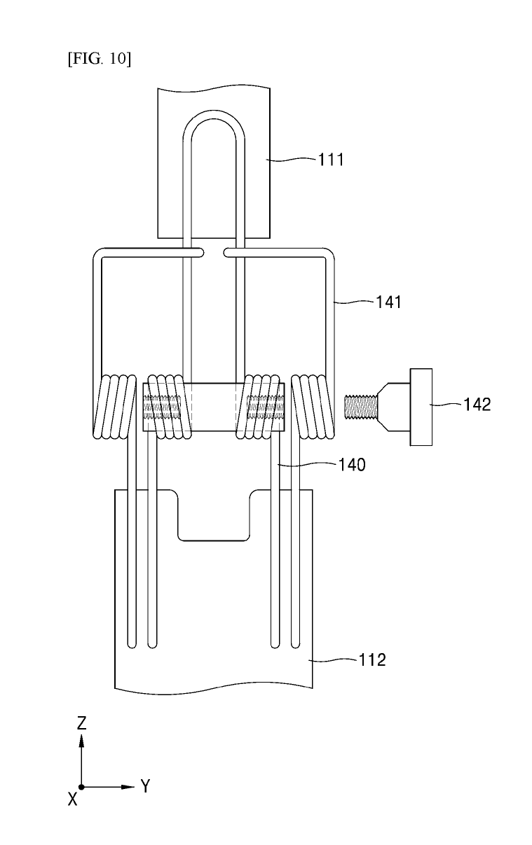

FIG. 10 is a conceptual diagram illustrating a second elastic portion, an auxiliary elastic portion, and a coupling member of a walking assistance device according to another embodiment of the present invention.

Referring to FIG. 10, the second elastic portion 140 which connects an upper body 111 and a lower outer body 112 may be installed together with the auxiliary elastic portion 141. In this case, the auxiliary elastic portion 141 may be concentric with the second elastic portion 140. In particular, the auxiliary elastic portion 141 may share the center with the second elastic portion 140 through the coupling member 142.

Specifically, the coupling member 142 may be inserted into the center of the second elastic portion 140 and fixed to the second elastic portion 140. In addition, the coupling member 142 may be formed to have parts detachable from each other, a part of the coupling member 142 may be coupled to the second elastic portion 140 and another part may be coupled to the auxiliary elastic portion 141 so that the center of the auxiliary elastic portion 141 can be connected to the center of the second elastic portion 140.

One end of the above-described auxiliary elastic portion 141 may be inserted into the lower outer body 112 and be secured in a fixed position. In addition, the other end of the auxiliary elastic portion 141 may be in contact with the second elastic portion 140. In this case, when the other end of the second elastic portion 140 rotates, the auxiliary elastic portion 141 may apply an elastic force to the second elastic portion 140, thereby further hindering the rotation of the second elastic portion 140. Therefore, when the user bends his/her knee or walks, the auxiliary elastic portion 141 may reduce the rotation of the other end of the second elastic portion 140 to support the load of the user and when the user stretches out his/her knee or walks, the auxiliary elastic portion 141 may provide a restoring force, along with the second elastic portion 140, to the upper body 111 to supplement the force necessary for the user's walking or action.

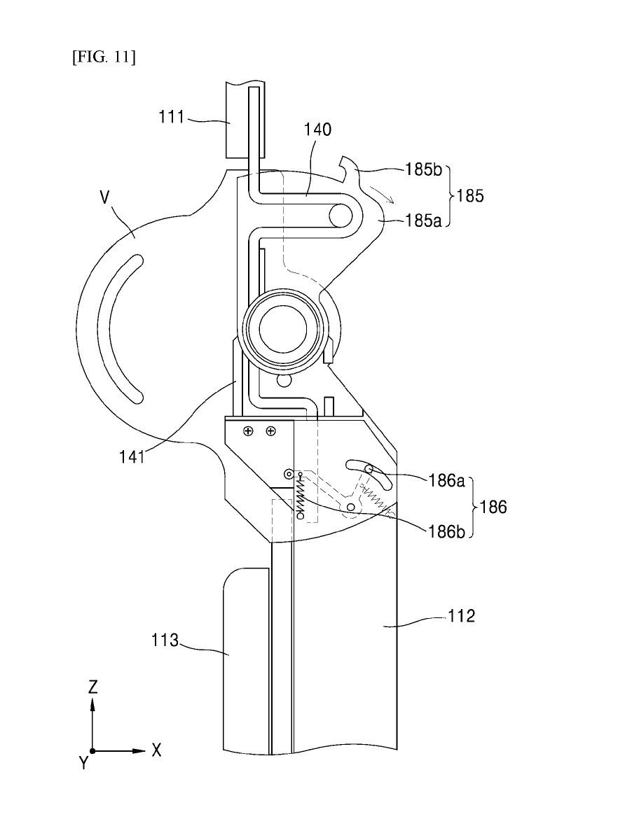

FIG. 11 is a conceptual diagram illustrating an auxiliary elastic portion, an elastic force adjusting portion, and a restraining portion of a walking assistance device according to still another embodiment of the present invention.

Referring to FIG. 11, a separate cover V may be fixedly installed on a lower outer body 112. In addition, the elastic force adjusting portion 185 may be rotatably installed on the cover V. One end of the auxiliary elastic portion 141 may be fixedly installed on a lower outer body 112 and the other end may be disposed to be selectively in contact with a second elastic portion 140.

The auxiliary elastic portion 141 may be fixed to the second elastic portion 140 in the same or similar manner to FIG. 10. In this case, separately, the elastic force adjusting portion 185 may be rotatably connected to a coupling member 142. The other end of the auxiliary elastic portion 141 may be installed on the elastic force adjusting portion 185 so that the contact between the other end of the auxiliary elastic portion 141 and the other end of the second elastic portion 140 may be separated.

For example, the elastic force adjusting portion 185 may include an elastic force adjusting body portion 185a connected to the coupling member 142 and the other end of the auxiliary elastic portion 141. In addition, the elastic force adjusting portion 185 may include an adjusting projection 185b protruding from the elastic force adjusting body portion 185a. In this case, the adjusting projection 185b may have a groove formed thereon.

The above-described elastic force adjusting portion 185 may be selectively coupled to the restraining portion 186 so that the auxiliary elastic portion 141 and the second elastic portion 140 can be separated from each other. In this case, the restraining portion 186 may include a restraining projection portion 186a rotatably disposed on the lower outer body 112 and a restraining projection elastic portion 186b disposed to be connected to the restraining projection portion 186a and the lower outer body 112 to provide a restoring force to the restraining projection portion 186a. In the case of the above structure, the restraining projection portion 186a may be formed to penetrate the lower outer body 112 and a guide hole in the form of a long hole may be formed in the lower outer body 112 to guide the motion of the restraining projection portion 186a. In addition, the restraining projection elastic portion 186b may be connected at a different position on the restraining projection portion 186a to provide a restoring force to the restraining projection portion 186a during the rotation of the restraining projection portion 186a.

In a normal case as described above, the auxiliary elastic portion 141 may be in contact with the second elastic portion 140 and move together so that the effects as described in FIG. 10 can be generated.

On the other hand, when it is intended to remove the effects caused by the auxiliary elastic portion 141 by using only the second elastic portion 140, the elastic force adjusting portion 185 may be rotated. In this case, the other end of the auxiliary elastic portion 141 may rotate together with the elastic force adjusting body portion 185a and the adjusting projection 185b may be in contact with the restraining projection portion 186a and be fixed to the restraining projection portion 186a. In this case, the elastic force adjusting body portion 185a may not rotate any longer and may be fixed so that the auxiliary elastic portion 141 can be separated from the second elastic portion 140.

In the opposite case, the elastic force adjusting body portion 185a may be rotated by releasing the contact between the adjusting projection 185b and the restraining projection portion 186a. At this time, the user may rotate the restraining projection portion 186a. In this case, the restraining projection portion 186a may be in a state of being exposed to the outside and it is possible to move the restraining projection portion 186a through a separate switch.

When the restraining projection portion 186a rotates in one direction, the restraining projection elastic portion 186b may apply a restoring force to the restraining projection portion 186a. In this case, the restraining projection portion 186a may release the restraint of the adjusting projection 185b, then may move to a specific range and return to an original state. When the restraint of the adjusting projection 185b is released as described above, the elastic force adjusting body portion 185a may rotate due to the restoring force of the auxiliary elastic portion 141 and the other end of the auxiliary elastic portion 141 may be in contact with the other end of the second elastic portion 140 to reinforce the elastic force during the rotation of the other end of the second elastic portion 140.

Specifically, in a normal state, for example, in a state in which there is no heavy load, the elastic force adjusting portion 185 may be restrained to the restraining projection portion 186a and be secured in a fixed position. On the contrary, in the case in which there is a heavy load or a force is required, the elastic force adjusting portion 185 may be separated from the restraining projection portion 186a, thereby maintaining a state in which the auxiliary elastic portion 141 is in contact with the second elastic portion 140.

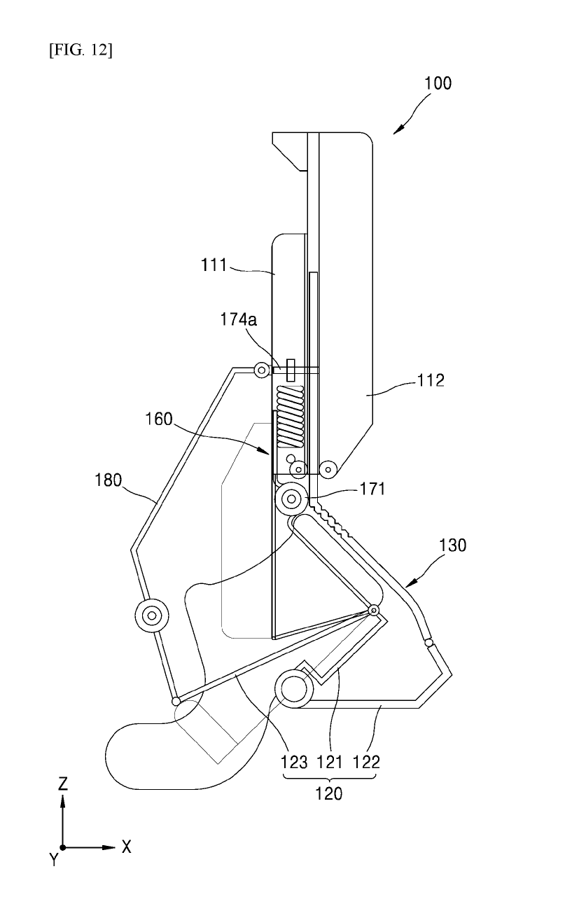

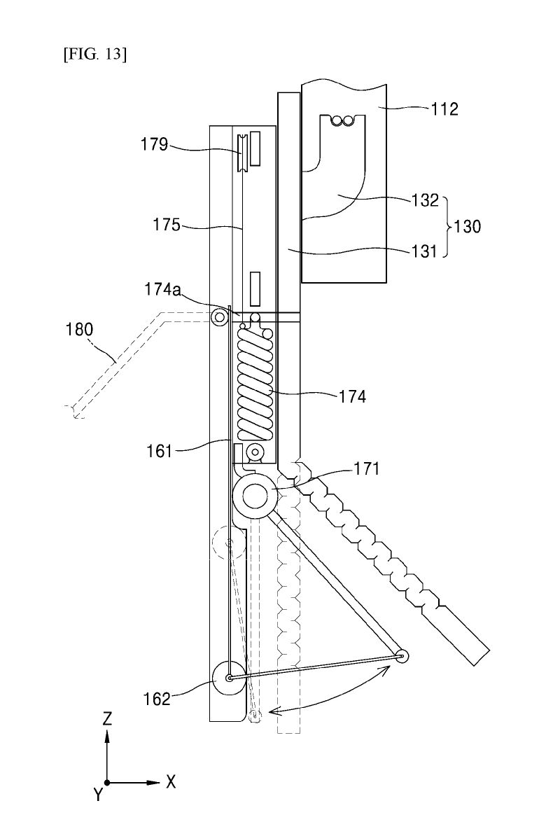

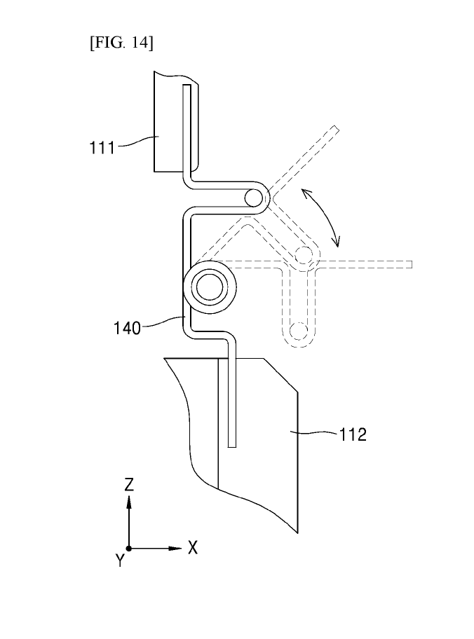

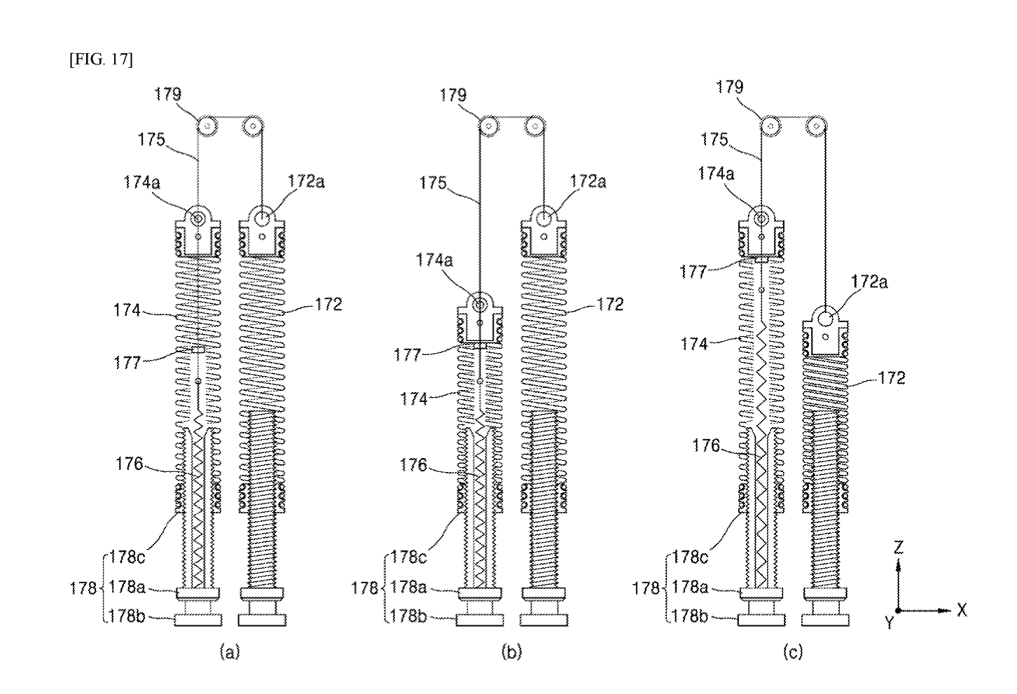

FIG. 12 is a conceptual diagram illustrating an operational state of the walking assistance device shown in FIG. 1. FIG. 13 is a conceptual diagram illustrating a part of the walking assistance device shown in FIG. 12. FIG. 14 is a conceptual diagram illustrating an operational state of a second elastic portion shown in FIG. 12. FIG. 15 is a conceptual diagram illustrating another embodiment of the loading portion and path guide portion shown in FIG. 9. FIG. 16 is a conceptual diagram illustrating a path guide portion shown in FIG. 14. FIG. 17 is a conceptual diagram illustrating a fourth elastic portion, a fourth elastic connector, a locking portion, a fifth elastic portion, a length-adjusting portion, a fifth elastic connector, and a sixth elastic portion, which are shown in FIG. 12.

Referring to FIGS. 12 to 17, a first elastic portion 120 may be bent or stretched when the user walks.

Specifically, when the user's foot is in the air, an external force is not applied to a first and second elastic body portions 121 and 122 of the first elastic portion 120 and a central angle of a first elastic connector 123 is maintained as an initial angle. A projection portion 132 is disposed on a lower side of a lower outer body 122 by an Achilles tendon body portion 131 connected to the second elastic body portion 122. The other end of a loading elastic portion 154 in contact with a contact portion 156 is disposed on a lower side of the lower outer body 112 by a restoring portion of the loading elastic portion 154.

<Foot Stepped On>

When the user's foot is in the air and then falls to the ground, the second elastic body 122 is brought into contact with the ground. A weight of the user may apply a force to the first elastic body portion 121 due to the second elastic body portion 122 in contact with the ground. In this case, the first and second elastic body portions 121 and 122 may be close to each other so that the first elastic connector 123 can be compressed. A restoring force which causes the first and second elastic body portions 121 and 122 to spread apart from each other may be stored in the compressed first elastic connector 123. When the first elastic connector 123 is compressed, the second elastic body portion 122 may apply a force to the Achilles tendon body portion 131.

The Achilles tendon body portion 131 may ascend along the lower inner body 113 and the projection portion 132 may ascend inside the lower outer body 112. In this case, the projection portion 132 may be in contact with the contact portion 156 while linearly moving, and may raise the contact portion 156. The contact portion 156 may be in contact with the other end of the loading elastic portion 154 and rotate the other end of the loading elastic portion 154. In this case, the other end of the loading elastic portion 154 may move upward while rotating. A restoring force which causes the other end of the loading elastic portion 154 to rotate may be stored in the loading elastic portion 154. In addition, a restoring force for compression may be stored in the eighth elastic portion 155.

When the user's foot is in the air, the user's knee may be stretched out or be bent. In the state in which the knee is stretched out, the upper body 111 and the lower outer body 112 may be arranged in a straight line. In this case, the second moving portion 153 may be disposed on an upper side of a first path guide portion 112b-1 and a first moving portion 151 may be disposed on an upper side of a first movement guide portion 112a. In the state in which the knee is bent, the second moving portion 153 may be disposed at a position which is not the upper side of the first path guide portion 112b-1 and the first moving portion 151 is also disposed at a positon which is not the upper side of the first movement guide portion 112a. As the user's knee flexion becomes greater, the first and second moving portions 151 and 153 may be disposed in directions closer to the lower sides of the first movement guide portion 112a and the first path guide portion 112b-1, respectively. Hereinafter, upward rotational movement of the other end of the loading elastic portion 154 in each state will be described in detail.

When the user's foot falls to the ground with the knee stretched out, an upper surface of the other end of the loading elastic portion 154 may be in contact with the second moving portion 153 disposed on the upper side of the first path guide portion 112b-1 during the upward rotational movement of the other end of the loading elastic portion 154.

When the user's foot falls to the ground with the knee bent, the upper surface of the other end of the loading elastic portion 154 may be in contact with the second moving portion 153 disposed at a position that is not an upper side of the first path guide portion 112b-1, during the upward rotational movement of the other end of the loading elastic portion 154. Then, the second moving portion 153 may be raised to the upper side of the first path guide portion 112b-1 due to the upward movement of the contact portion 156. The ascent of the second moving portion 153 may raise the loading connector 152 and allow the first moving portion 151 connected to the loading connector 152 to move up and down along the first movement guide portion 112a. In addition, the first moving portion 151 may raise a bent part of the second elastic portion 140 and the second elastic portion 140 may be stretched by a restoring force. In this case, the second elastic portion 140 may apply a force to the upper body 111 and the upper body 111 and the lower outer body 112 may form a straight line due to the applied force.

It may be preferable that the upper surface of the other end of the loading elastic portion 154 has a sloping shape. As described above, in all cases where the user's foot falls to the ground with the knee stretched out and with the knee bent, the upper surface of the other end of the loading elastic portion 154 is in contact with the second moving portion 153 during the upward rotational movement of the other end of the loading elastic portion 154. The second moving portion 153 in contact with the slope of the upper surface of the other end of the loading elastic portion 154 may slide along the slope and move from the first path guide portion 112b-1 to the second path guide portion 112b-2. After the second moving portion 153 moves (evades) to the second path guide portion 112b-2, the other end of the loading elastic portion 154 and the contact portion 156 may move further upward while rotating. Then, the second moving portion 153 may be disposed on a lower surface of the other end of the loading elastic portion 154. In this case, the second moving portion 153 may be secured in a fixed position by the restoring force of the second elastic portion 140 and the elastic force of the loading elastic portion 154. That is, the second moving portion 153 tends to move upward due to the restoring force of the second elastic portion 140 and the other end of the loading elastic portion 154 tends to move toward the lower side of the second moving portion 153 due to the restoring force of the loading elastic portion 154, so that the second moving portion 153 can be maintained at a specific fixed position.

While the Achilles tendon body portion 131 is ascending, a release projection 133 installed on the Achilles tendon body portion 131 may rise along a lower outer body long hole 113a. In addition, a lower side of a fourth long hole 131a formed in the Achilles tendon body portion 131 may be in contact with a fourth elastic connector 172a and allow the fourth elastic portion 172a to be raised. At this time, a sixth elastic portion 176 connected to the first wire 175 may pull the first wire 175 downward. In this case, the first wire 175 may be bent by a guide roller 179 and be connected to the sixth elastic portion 176 so that the fifth elastic loading portion 177 can move downward according to the movement of the first wire 175 (refer to FIG. 17A).

When the Achilles tendon body portion 131 ascends, the fifth elastic connector 174a is in contact with the lower side of the sixth long hole and moves upward as the lower side of the fourth long hole 131a moves upward by the lower side of the fourth long hole 131a. Accordingly, the fifth elastic portion 174 may be extended together with the fourth elastic portion 172.

As the fifth elastic connector 174a ascends, the fifth elastic connector 174a may raise a first linear motion portion 160 connected to the fifth elastic connector 174a. At this time, a first linear motion body portion 161 may rise together with the fifth elastic connector 174a and the first linear roller 162 may move together with the first linear motion body portion 161.

When the first linear roller 162 moves, one end of the second connector 163 may be raised along the first linear roller 162. At this time, the first linear motion body portion 161 and the second connector 163 may form an obtuse angle. A restoring force may be stored in the third elastic portion 171 connected to the other end of the second connector 163 by deforming the third elastic portion 171. In addition, the seventh elastic portion 180 connected to the fifth elastic connector 174a may apply a force to the fifth elastic connector 174a, thereby causing the fifth elastic connector 174a to be in contact with the lower side of the sixth long hole. When the fourth elastic connector 172a moves as described above, an end of the fourth elastic portion 172 may be caught by the locking portion 173 and be secured in a fixed position. Specifically, when the end of the fourth elastic portion 172 continuously rises, the end touches the locking portion 173 and rotates the locking potion 173, the end of the fourth elastic portion 172 is inserted into a groove formed on the locking portion 173, and then the locking portion 173 rotates back and returns to an original state, thereby restraining the fourth elastic portion 172.

When the above-described operation is performed, the cushioning portion 181 may be deployed. Specifically, when the second wire 182 is pulled due to the ascent of the projection portion 132, the cushioning portion 181 may be deployed and interposed between the upper body 111 and the thigh of the user. In this case, the second wire 182 is moved while being bent at least once by the bending roller 183 so that the cushioning portion 181 can be deployed.

<Foot Raised>

Meanwhile, when the user raises a foot, the first elastic portion 120 may be deformed to apply a force to the ground, thereby assisting the user in walking.

Specifically, when the second elastic body portion 122 is separated from the ground, the second elastic body portion 122 may be spaced apart from the first elastic body portion 121. At this time, the Achilles tendon body portion 131 connected to the second elastic body portion 122 may move downward.

When the Achilles tendon body portion 131 moves downward, the projection portion 132 may also move downward. At this time, when the projection portion 132 moves, the projection portion 121 may release the force exerted on the contact portion 156. The other end of the loading elastic portion 154 in contact with the contact portion 156 may rotate to return to an initial state. In addition, the eighth elastic portion 155 connected to the loading elastic portion 154 may return to an original state.

The contact portion 156 may descend according to the rotation of the loading elastic portion 154 and the operation of the eighth elastic portion 155. At this time, the second moving portion 153 may move downward together with the contact portion 156 along the first path guide portion 112b-1. At this time, the loading connector 152 and the first moving portion 151 are descended according to the movement of the second moving portion 153, so that the bent part of the second elastic portion 140 may be rotated downward. At this time, the first moving portion 151 may linearly move toward a lower side of the lower outer body 112 along the first movement guide portion 112a. In addition, the second moving portion 153 may move along the first path guide portion 112b-1.

When the second moving portion 153 descending together with the contact portion 156 may move along the first path guide portion 112b-1 as described above and descends by a certain distance or more, the contact with the contacting portion 156 may be released. The radius of rotation of the loading elastic portion 154 is fixed and the radius of rotation of the contact portion 156 which corresponds to the radius of rotation of the loading elastic portion 154 is also fixed. The second moving portion 153 may deviate from the fixed radius of rotation of the contact portion 156 within the first path guide portion 112b-1. At this time, the second moving portion 153 may be released from the contact with the contact portion 156. When the contact between the second moving portion 153 and the contact portion 156 is released, a descending force exerted on the second elastic portion 140 by the second moving portion 153 is released. That is, the upper body 111 and the lower outer body 112 may form a straight line by a restoring force of the second elastic portion 140.

Positions of the first path guide portion 112b01 and the second path guide portion 112b-2 may be adjusted by the position adjusting portion 112b-3. At this time, the position adjusting portion 112b-3 may be connected to one end of the first path guide portion 112b-1 and be rotatably installed in the lower outer body 112. In particular, the position adjusting portion 112b-3 may be formed in the shape of a bolt and be rotated to adjust the position of the path guide portion 112, thereby controlling an extent to which the loading portion 150 rises. In addition, a folded angle of the second elastic portion 140 is adjusted by adjusting the position adjusting portion 112b-3 so that an angle formed by the upper body 111 and the lower outer body 112 can be adjusted.

The other end of the loading elastic portion 154 may be rotated by a restoring force and may stop rotating when it reaches the stopper 157. At this time, the contact portion 156 may be in contact with the stopper 157 and stop the linear motion.

When the Achilles tendon body portion 131 moves downward, the release projection 133 of the Achilles tendon body portion 131 may move downward. At this time, the fourth elastic connector 172a may be secured in a fixed position in a state of being restrained by the locking portion 173. The fourth long hole 131a may descend in response to the downward movement of the Achilles tendon body portion 131. As the fourth elastic connector 172a restrained by the locking portion 173 is secured in a fixed position and the fourth long hole 131a in which the fourth elastic connector 172a is disposed moves relatively downward, the fourth elastic connector 172a may be disposed at an upper part of the fourth long hole 131a.

The release projection 133 may apply a force to a part of the locking portion 173 while moving downward. At this time, the locking portion 173 may release the restraint of the end of the fourth elastic portion 172 while rotating. In the above case, the fourth elastic portion 172 may move downward.

When the Achilles tendon body portion 131 descends, the fifth elastic connector 174a may move downward along with the Achilles tendon body portion 131 by the restoring force of the sixth elastic portion 176. When the fourth elastic connector 172a is released from the locking portion 173 after the fifth elastic connector 174a descends, the fourth elastic portion 172 may pull the first wire 175 while moving downward. Due to a tension of the first wire 175, the length of the sixth elastic portion 176 connected to the first wire 175 may be extended and the fifth elastic loading portion 177 secured to the first wire 175 may rise.

Due to the ascent of the fifth elastic loading portion 177, the fifth elastic connector 174a in contact with the fifth elastic loading portion 177 may also ascend (refer to FIG. 17B). At this time, the length of the fourth elastic portion 172 may be reduced and the lengths of the fifth elastic portion 174 and the sixth elastic portion 176 may be extended. In this case, the fifth elastic connector 174a may freely move in the fifth long hole and the sixth long hole. According to the change in length of the fourth elastic portion 172 and the ascent of the fifth elastic loading portion 177, ultimately the fourth elastic connector 172a may be disposed on a lower side and the fifth elastic connector 174a may be disposed on an upper side (refer to FIG. 17C).

When the user lifts his/her foot from the ground, the fifth elastic connector 174a may descend and then ascend again, as shown in FIG. 17.

In response to the descent of the fifth elastic connector 174a, the first linear motion body portion 161 and one end of the seventh elastic portion 180, which are connected to the fifth elastic connector 174a, may also descend. As one end of the seventh elastic portion 180 descends, the other end of the seventh elastic portion 180 may also descend. In response to the descent of the first linear motion body portion 161, the first linear roller 162 descends, and accordingly, one end of the second connector 163 connected to the first linear roller 162 may descend while the other end of the second connector 163 connected to the third elastic portion 171 may ascend. When the other end of the second connector 163 ascends due to the relative disposition of the first linear motion portion 160 and the third elastic portion 171, the user's ankle is extended. In a case where the user lifts his/her foot that is touching the ground, the extension of the user's foot may allow the user to strongly push off the ground. The descent of the seventh elastic portion 180 may assist the user in extending his/her ankle. That is, the second connector 163 may move in a direction in which an angle formed with the first linear motion body portion 161 decreases. When the second connector 163 moves, the part of the Achilles tendon body portion 131 where the concavo-convex shape is formed may be deformed in the same or similar direction as that of the second connector 163 and thereby be bent. In particular, the concavo-convex part of the Achilles tendon body portion 131 may be deformed without obstructing a path of a heel region when the ankle is bent. As one end and the other end of the seventh elastic portion 180 are spaced apart from each other, a restoring force to cause an angle between the two ends to be reduced may be stored in the seventh elastic portion 180.

In response to the ascent of the fifth elastic connector 174a, the first linear motion body portion 161 and one end of the seventh elastic portion 180, which are connected to the fifth elastic portion 174a, may ascend. At this time, the user's ankle may be bent by a restoring force of the seventh elastic portion 180.

When the Achilles tendon portion 130 ascends as described above, the lower outer body 112 and the lower inner body 113 may form a straight line so that the user's foot can be completely extended. In addition, when the Achilles tendon portion 130 ascends, each elastic portion may store a restoring force or an elastic force. On the contrary, when the Achilles tendon portion 130 descends, the first elastic portion 120 may provide the user with a force necessary for walking. Also, the loading portion 150, the second elastic portion 140, and the like may provide the user with a force necessary for bending a knee. Moreover, when the user walks, the first elastic portion 120, the loading portion 150, the second elastic portion 140, and the like may provide the user with a force for moving forward, thereby providing the force necessary for the user to walk.

Meanwhile, when the user wearing the walking assistance device 100 as described above crouches down, the bent part of the second elastic portion 140 may push the loading portion 150 downward. At this time, the first loading connector 152a and the second loading connector 152b are folded with each other to block the force exerted on the other elements of the walking assistance device 100. At this time, the second elastic portion 140 may support the upper body 111 through the restoring force and provide the restoring force to the user when the user stands back up, and thereby assist with a user's standing upright with less force.

Therefore, the walking assistance device 100 may provide the user with convenience. In addition, the walking assistance device 100 assists with a user's walk by providing a force necessary for the user to walk.

The walking assistance device 100 may be a great help for walking and ay assist in the walking of people having various conditions, such as people suffering from degenerative arthritis, people with an abnormal gait, people who work in a crouching position all day, and people who need to walk a lot. Also, embodiments of the present invention may assist with a user's walk when the user goes up and down stairs, thereby improving the user's convenience

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Reference Numerals

| | |
|---|---|
| 100: WALKING ASSISTANCE DEVICE | 157: STOPPER |
| 111: UPPER BODY | 160: FIRST LINEAR MOTION PORTION |
| 112: LOWER OUTER BODY | 171: THIRD ELASTIC PORTION |
| 113: LOWER INNER BODY | 172: FOURTH ELASTIC PORTION |
| 114: SHOE-SECURING PORTION | 173: LOCKING PORTION |
| 120: FIRST ELASTIC PORTION | |
| 174: FIFTH ELASTIC PORTION | |
| 130: ACHILLES TENDON PORTION | |
| 175: FIRST WIRE | |
| 140: SECOND ELASTIC PORTION | 176: SIXTH ELASTIC PORTION |
| 141: AUXILIARY ELASTIC PORTION | |
| 177: FIFTH ELASTIC LOADING PORTION | |
| 142: COUPLING MEMBER | |
| 178: LENGTH-ADJUSTING PORTION | |
| 150: LOADING PORTION | 179: GUIDE ROLLER |
| 151: FIRST MOVING PORTION | |
| 180: SEVENTH ELASTIC PORTION | |
| 152: LOADING CONNECTOR | 181: CUSHIONING PORTION |
| 153: SECOND MOVING PORTION | 182: SECOND WIRE |
| 154: LOADING ELASTIC PORTION | 183: BENDING ROLLER |
| 155: EIGHTH ELASTIC PORTION | |
| 184: DISTANCE ADJUSTING PORTION | |
| 156: CONTACT PORTION | |
| 185: ELASTIC FORCE ADJUSTING PORTION | |
| 186: RESTRAINING PORTION | 190: SECURING PORTION |

1. A walking assistance device comprising:
an upper body disposed on a thigh of a user;
a lower outer body rotatably connected to the upper body and disposed on a calf of the user;
a lower inner body disposed to at least partially overlap the lower outer body;
a first elastic portion which has a bent part in contact with the ground so as to provide an elastic force during a user's walk;
an Achilles tendon portion connected to one end of the first elastic portion and slidably connected to the lower outer body and the lower inner body,
wherein the first elastic portion includes:
a first elastic body portion on which a shoe is seated;
a second elastic body portion formed to be bent from the first elastic body portion and be in contact with the ground; and
a first elastic connector rotatably connected to the first and second elastic body portion and allowing the first and second elastic body portions to form a predetermined angle.

2. The walking assistance device of claim 1, further comprising:
a first linear motion portion which is installed slidably with respect to the lower inner body and connected to the Achilles tendon portion and linearly moves with respect to the lower inner body according to a motion of the Achilles tendon portion.

3. The walking assistance device of claim 1, further comprising:
a fourth elastic portion which is installed in the lower inner body and is connected to the Achilles tendon portion to provide a restoring force to the Achilles tendon portion according to a motion of the Achilles tendon portion; and
a fourth elastic connector connected to the fourth elastic portion and linearly-movably inserted into the Achilles tendon portion.

4. The walking assistance device of claim 1, further comprising:
a second elastic portion interposed between the upper body and the lower outer body, thereby rotatably connecting the upper body and the lower outer body; and
a loading potion which is connected to a bent part of the second elastic portion and movably installed in the lower outer body, and has a part in contact with the Achilles tendon portion to provide a force to the bent part of the second elastic portion according to a motion of the Achilles tendon portion.

5. (canceled)

6. The walking assistance device of claim 1, wherein the Achilles tendon portion includes:
an Achilles tendon body portion slidably connected to the lower outer body and the lower inner body; and
a projection portion which is formed to protrude from the Achilles tendon body portion to an inside of the lower outer body and is partially in contact with the loading portion to apply a force to the loading portion.

7. The walking assistance device of claim 6, wherein a concavo-convex shape is formed on an outer surface of at least a part of the Achilles tendon body portion to allow a shape of the Achilles tendon body to be varied.

8. The walking assistance device of claim 2, further comprising:
a second connector rotatably connected to the first linear motion portion; and
a third elastic portion having one end installed in the lower inner body and the other end connected to the second connector to provide a restoring force to the first linear motion portion.

9. (canceled)

10. The walking assistance device of claim 8, wherein the first linear motion portion includes:
a first linear motion body portion disposed linearly movably with respect to the lower inner body and connected to the Achilles tendon portion; and
a first linear roller connected to the first linear motion body portion and the second connector and slidably installed in the lower inner body.

11. The walking assistance device of claim 3, further comprising a locking portion installed in the lower inner body and selectively restraining a part of the fourth elastic portion.

12. The walking assistance device of claim 11, wherein the Achilles tendon portion includes a release projection which is disposed to be inserted into the lower outer body and releases the restraint of the fourth elastic portion by being brought into contact with the locking portion and moving the locking portion according to a motion of the Achilles tendon portion.

13. The walking assistance device of claim 3, further comprising a fifth elastic portion installed in the lower inner body and selectively connected to the fourth elastic portion via a first wire to apply a force to the fourth elastic portion according to a motion of the fourth elastic portion.

14. The walking assistance device of claim 13, further comprising a length- adjusting portion installed in the lower inner body and coupled with at least one of the fourth elastic portion and the fifth elastic portion to vary an initial position of at least one of the fourth elastic portion and the fifth elastic portion.

15. (canceled).

16. The walking assistance device of claim 13, further comprising a fifth elastic connector which is linearly movably inserted into the lower inner body and the Achilles tendon portion and is connected to the fifth elastic portion.

17-19. (canceled).

20. The walking assistance device of claim 1, wherein the loading portion includes:
a first moving portion linearly moving inside the lower outer body;
a loading connector connected to the first moving portion;
a second moving portion connected to the loading connector and moving inside the lower outer body during a motion of the first moving portion;
a path guide portion which is installed on the lower outer body and guides a path along which the moving portion internally moves; and
a loading elastic portion which moves the second moving portion by applying a restoring force thereto and moves in contact with the Achilles tendon portion.

21. The walking assistance device of claim 20, wherein the loading connector is foldable.

22. The walking assistance device of claim 20, wherein a position of the path guide portion is variable.

23. The walking assistance device of claim 20, wherein the path guide portion includes a first path guide portion along which the second moving portion moves and a second path guide portion which is formed to protrude from the first path guide portion and guides the second moving portion to a path different from a path of the second moving portion moving along the first path guide portion.

24. The walking assistance device of claim 20, wherein the loading portion further includes an eighth elastic portion which is installed on the lower outer body and connected to the loading elastic portion to provide a restoring force to the loading elastic portion.

25. The walking assistance device of claim 20, wherein the loading portion further includes a contact portion which is slidably installed on the lower outer body and is selectively brought into contact with the Achilles tendon portion according to a motion of the Achilles tendon portion, thereby moving the loading elastic portion.

26. The walking assistance device of claim 1, further comprising:
an auxiliary elastic portion connected to the lower outer body and having one end in contact with the second elastic portion;
a coupling member which is installed at a center of the second elastic portion and at which a center of the auxiliary elastic portion is installed; and
an elastic force adjusting portion installed on one end of the auxiliary elastic portion and rotatably installed on the coupling member.

27. (canceled).
